(19) United States
(12) Patent Application Publication
(10) Pub. No.: US 2007/0113734 A1
(43) Pub. Date: May 24, 2007

(54) Piston for a two-stroke engine and a method of making the same

(75) Inventors: Siegfried Haussermann, Markgroningen (DE); Klaus Schnaithmann, Winnenden (DE); Werner Kreuzberger, Remseck (DE); Jorg Schlossarczyk, Winnenden (DE); Werner Geyer, Berglen (DE)

Correspondence Address: WALTER OTTESEN, PO BOX 4026, GAITHERSBURG, MD, 20885-4026, US

(73) Assignee: Andreas Stihl AG & Co. KG

(21) Appl. No.: 11/603,840

(22) Filed: Nov. 24, 2006

(30) Foreign Application Priority Data
Nov. 23, 2005 (DE) 10 2005 055 787.2

(51) Int. Cl. F16J 1/04

(52) U.S. Cl. 92/208

(57) ABSTRACT

A piston (5) for a two-stroke engine (1) has a piston base (19) and at least one piston pin boss (24). The piston pin boss (24) has a bore for accommodating a piston pin. At the piston pin boss (24), two mutually opposite-lying planar clamping surfaces (36, 37) are formed. The piston (5) is produced in a pressure die cast process and is thereafter clamped at the clamping surfaces (36, 37) and a stop surface (35). In this clamping state, all machining operations of the piston (5) can be carried out so that a high dimensional stability of the piston (5) results.

### CROSS REFERENCE TO RELATED APPLICATION

This application claims priority of German patent application no. 10 2005 055 787.2, filed Nov. 23, 2005, the entire content of which is incorporated herein by reference.

### BACKGROUND OF THE INVENTION

U.S. Pat. No. 3,460,239 discloses a piston having a piston base and two piston pin bosses. The piston pin bosses each have a bore for the piston pin. A casting process is provided for manufacturing the piston. Thereafter, the piston is machined in a machining method. For this purpose, the piston is clamped at its inner side in two mutually spaced planes. In order to position the piston in the direction of its longitudinal center axis, the piston is pressed with a pressure piece against a stop arranged on the outer side of the piston base. The pressure piece is arranged on the inner side of the piston base. Because of the stop, a machining of the piston base in this clamped state is not possible. The piston must be clamped anew for machining the piston base. The renewed clamping leads to the situation that additional tolerances in machining result which lead to a deteriorated dimensional stability of the piston. The piston must be designed to be stronger in order to prevent a malfunction thereof because all tolerances must be considered. This leads to greater wall thicknesses of the piston and an increased weight. Clamping the piston on the inner side of the piston skirt can lead to a deformation of the piston and therefore to a deteriorated dimensional stability of the machined piston skirt.

### SUMMARY OF THE INVENTION

It is an object of the invention to provide a piston of the kind described above which can be manufactured with reduced tolerances. A further object of the invention is to provide a method for making the piston.

The piston of the invention is for a two-stroke engine. The piston includes: a piston body having a base; two piston pin bosses formed on the body; the piston pin bosses having respective bores formed therein for accommodating a piston pin; and, the piston pin bosses each having opposite-lying planar first and second clamping surfaces formed thereon.

The piston has two opposite-lying planar clamping surfaces on the piston pin bosses. For this reason, the piston can be positioned on a clamping tool and can be gripped thereby. The clamping tool grips the two clamping surfaces at the piston pin boss. In this way, the piston skirt is not significantly deformed in the clamped state of the piston so that the piston skirt can be machined with high accuracy in the clamped state of the piston.

The piston is especially manufactured in a pressure die-casting process. To permit making the clamping surfaces in the pressure die-casting process, the clamping surfaces extend parallel to the longitudinal axis of the bore in the piston pin boss and extend inclined to a transverse plane of the piston. The clamping surfaces are especially inclined at an angle of 1° to 5° to the transverse plane of the piston. The transverse plane includes the longitudinal center axis of the piston and the longitudinal axis of the bore of the piston pin boss. The slight inclination ensures that the piston can be ejected. At the same time, a reliable clamping of the piston and a simple alignment of the piston to the clamping tool are possible because of the slight inclination and the parallel alignment to the longitudinal axis of the bore in the piston pin boss.

Preferably, the two clamping surfaces lie at the same spacing to a transverse plane of the piston. The transverse plane contains the longitudinal center axis of the piston and the longitudinal axis of the bore of the piston pin boss. Because of the arrangement of the clamping surfaces at the same distance to the transverse plane, the piston is clamped symmetrically to the transverse plane so that the positioning of the clamping tool to the longitudinal center axis of the piston is possible in a simple manner. The clamping surface, which is arranged on one side of the transverse plane, is narrower in the direction of the longitudinal axis of the bore of the piston pin boss than the clamping surface arranged on the opposite-lying side of the transverse plane. Because of the different widths of the clamping surfaces, a positioning of the piston relative to a clamping tool is possible in a simple manner. For example, a clamping, which is rotated by 180° about the longitudinal center axis of the piston, is prevented by mechanical measures as a consequence of the different geometries of the clamping surfaces. Accordingly, and in a simple manner, a properly-positioned clamping of the piston is ensured.

The piston is especially provided for a two-stroke engine which operates with a scavenging prestore. For this purpose, it is practical that the piston has at least one piston pocket open toward the piston skirt. The piston pocket connects an air channel of the two-stroke engine with the transfer window of a transfer channel so that scavenging prestored air is stored in advance in the transfer channel. The piston has a center plane which contains the longitudinal center axis of the piston and extends perpendicularly to the longitudinal axis of the bore of the piston pin boss. The piston pocket and the inner wall of the piston are configured to be especially nonsymmetrical to the center plane in the region of the piston pocket. The nonsymmetrical configuration of the piston pocket permits a conduction of air to the transfer channels with slight flow resistance. For approximately the same wall thickness of the piston, there results also a nonsymmetrical configuration of the inner wall of the piston in the region of the piston pocket. The nonsymmetrical configuration of the inner wall of the piston makes possible the correctly positioned clamping of the piston so that the manufacture of the piston is simplified.

According to a feature of the invention, a stop surface is configured on the inner side of the piston base. The stop surface is configured to be planar and is arranged perpendicularly to the longitudinal center axis of the piston. The stop surface is configured on the inner side of the piston base and the piston does not have to be pressed against a stop on the outer side of the piston for positioning. For this reason, the piston skirt as well as the piston base can be machined in one clamped state. In this way, the piston skirt and the piston base can be machined to higher accuracy with respect to each other and with respect to the stop surface. Because of the reduced tolerances, the thickness of piston skirt and piston base can be designed comparatively low so that the piston has a reduced weight. Practically, the stop surface has a width of 10% to 25% of the piston diameter and a length of 10% to 25% of the piston diameter. The piston thickness advantageously is 2.5% to 7%, especially 5%, of the piston diameter. The wall thickness of the piston skirt at the elevation of the longitudinal axis of the bore in the piston pin boss amounts advantageously to 1% to 3%, especially 2.5%, of the piston diameter.

A clamping tool having a stop is moved up to the stop surface of the piston and the piston base is pressed against a counter holder by the clamping tool for a method for making a piston having a planar stop surface on the inner side of the piston base and at least two opposite-lying clamping surfaces arranged on a piston pin boss. Thereafter, the piston is gripped by the clamping tool at the clamping surfaces and clamped. After clamping the piston at the clamping surfaces, the counter holder is removed and the piston is machined on the piston skirt and the piston base in this clamping state.

The method for making the piston provides for a positioning of the piston relative to the clamping tool exclusively at the clamping surfaces and the stop surface on the piston base, that is, exclusively on the inner side of the piston. The counter holder functions only for the purpose to ensure that the stop of the clamping tool lies against the stop surface of the piston. Because the piston is exclusively clamped on its inner side, a machining of the piston skirt and also a machining of the piston base is possible in this clamped state. The machining of the piston skirt as well as the machining of the piston base accordingly takes place with the same tolerances between the stop surface, the clamping surfaces and the clamping tool. In this way, the piston skirt and the piston base can be machined to low tolerances with respect to each other so that the piston can be accurately manufactured and the wall thicknesses can be designed to be thin because of the reduced tolerances.

After clamping of the piston, the bore is drilled in the piston pin boss. The bore in the piston pin boss is drilled at reduced clamping force on the clamping surfaces and with the counter holder arranged on the piston base. The bore in the piston pin boss can already be made in advance of removing the counter holder. It can, however, also be practical to first machine the piston skirt and the piston base and thereafter arrange the counter holder anew on the piston base in order to drill the piston pin boss. The reduction of the clamping force at the clamping surfaces ensures that only low stresses are present during the drilling operation in the piston pin boss. In this way, it is ensured that no warping of the bore results when releasing the clamping tool. The bore in the piston pin boss can be made thereby at high accuracy. Because the clamping force is not reduced and the clamping of the piston is, however, not released, the bore in the piston pin boss can be made with low tolerances relative to the piston skirt and the piston base.

In the clamped state, an annular slot is cut at the bore in the piston pin boss and a bore is drilled at the annular slot. The annular slot and the bore function for receiving a holding ring for the piston pin. It is practical to cut at least one slot for a piston ring in the clamped state. In this way, it is possible to run through the entire machining operation of the piston in a single clamped state thereof so that the piston can be made with low tolerances. At the same time, the one-time clamping of the piston leads to a simplification of the manufacturing process.

It is practical that the clamping surfaces of the piston are configured nonsymmetrically to the center plane. The center plane contains the longitudinal center axis of the piston and the longitudinal axis of the bore in the piston pin boss. The clamping tool and the piston are aligned to each other at the nonsymmetry in advance of the clamping of the piston. The piston is made in a pressure die-casting method in advance of the machining operation. The stop surface and the clamping surfaces are made in the pressure die-casting process. The stop surface and the clamping surfaces can be made with sufficiently high accuracy in a pressure die-casting process. In this way, it is possible to completely machine the piston in only one clamping state.

### BRIEF DESCRIPTION OF THE DRAWINGS

The invention will now be described with reference to the drawings wherein:

FIG. 1 is a schematic longitudinal section taken through a two-stroke engine;

FIG. 2 is a section view taken along line II-II in FIG. 1;

FIG. 3 is a side elevation view of the piston of FIGS. 1 and 2;

FIG. 4 is a longitudinal section taken through the piston of FIG. 3;

FIG. 5 is a section view taken along line V-V in FIG. 4;

FIG. 6 is a schematic plan view of a clamping device; and,

FIG. 7 is a side elevation view of the clamping device of FIG. 6 viewed in the direction of arrow VII in FIG. 6.

### DESCRIPTION OF THE PREFERRED EMBODIMENTS OF THE INVENTION

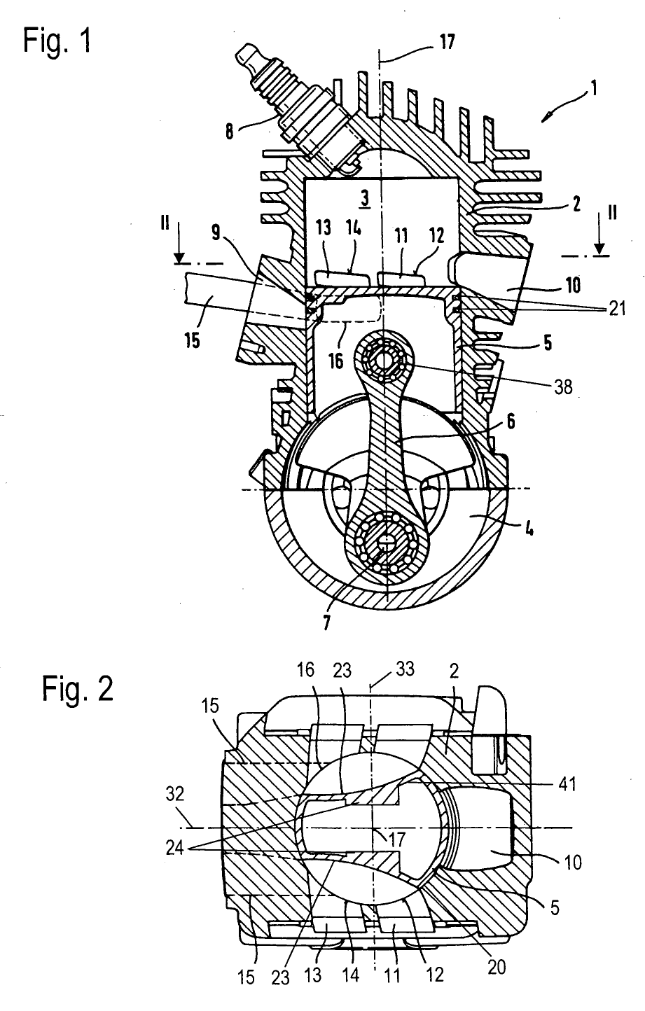

The two-stroke engine 1 shown in FIG. 1 is provided as a drive motor for a portable handheld work apparatus such as a motor-driven chain saw, a cutoff machine, a brushcutter or the like. The two-stroke engine 1 is configured as a single cylinder engine and has a cylinder 2 wherein a combustion chamber 3 is formed. The combustion chamber 3 is delimited by a piston 5 which is journalled for reciprocal movement in the cylinder 2. The piston 5 drives a crankshaft 7 via a connecting rod 6. The crankshaft 7 is rotatably journalled in a crankcase 4 and functions to drive the work tool of the work apparatus. The connecting rod 6 is attached to the piston 5 via a piston pin 38.

An intake 9 for an air/fuel mixture opens at the cylinder 2. The intake 9 is slot controlled by the piston 5 and is connected to the crankcase 4 in the region of top dead center of the piston 5. A discharge 10 for exhaust gases leads from the combustion chamber 3. A spark plug 8 projects into the combustion chamber 3. The piston 5 has two piston rings 21 which seal the combustion chamber 3 to the crankcase 4 during operation. Furthermore, an air channel 15 having an air inlet 16 opens at the cylinder 2 on both sides of the intake 9. The crankcase 4 is connected to the combustion chamber 3 in the region of bottom dead center shown in FIG. 1 via transfer channels 11 and 13. The discharge-near transfer channel 11 opens via a transfer window 12 into the combustion chamber 3 and the intake-near transfer channel 13 opens with a transfer window 14.

As shown in the section view of FIG. 2, a first pair of transfer channels 11 and 13 lie opposite a second pair of transfer channels 11 and 13 on the cylinder 2. The transfer channels 11 and 13 are arranged symmetrically to the center plane 32 of the piston 5. The center plane 32 partitions the intake 9 and the discharge 10 of the cylinder 2 approximately centrally and contains a cylinder longitudinal axis 17. The piston 5 is moveably journalled in the cylinder 2 in the direction of the cylinder longitudinal axis 17. In the section view shown in FIG. 2, the piston 5 is shown in the region of top dead center. As shown in FIG. 2, an air channel 15 opens at the cylinder 2 on each side of the center plane 32. The piston 5 has two piston pockets 23 which are configured symmetrically to the center plane 32. The piston pockets 23 extend from the piston skirt 20 into the cylinder interior. In the region of top dead center of the piston 5, the two air channels 15 are connected to the transfer windows 12 and 14 of the transfer channels 11 and 13 via the piston pockets 23 so that substantially fuel-free combustion air flows out of the air channels 15 into the transfer channels and displaces the air/fuel mixture from the transfer channels to the crankcase 4. As FIG. 2 shows, the piston 5 has two piston pin bosses 24. The piston pin 38 is journalled in the piston pin bosses 24.

During the operation of the two-stroke engine 1, an air/fuel mixture is drawn from the intake 9 into the crankcase 4 in the region of top dead center of the piston 5. At the same time, substantially fuel-free combustion air flows from the air channels 15 via the piston pockets 23 into the transfer channels 11 and 13 and fills these with air. The air/fuel mixture is compressed in the crankcase with the downward stroke of the piston 5 toward the crankcase 4. As soon as the transfer windows 12 and 14 open to the combustion chamber 3, the prestored combustion air flows out of the transfer channels 11 and 13 into the combustion chamber 3 and flushes the still-present exhaust gases from the previous combustion cycle from the combustion chamber 3 through the discharge 10. Thereafter, the air/fuel mixture flows out of the crankcase 4 via the transfer channels 11 and 13 into the combustion chamber 3. During the upward stroke of the piston 5, first the transfer windows 12 and 14 are closed by the piston 5 and then the discharge 10 is closed thereby. The air/fuel mixture is compressed in the combustion chamber 3 and ignited by the spark plug 8 in the region of top dead center of the piston 5. The combustion of the mixture accelerates the piston 5 again in a direction toward the crankcase 4. As soon as the discharge 10 opens, the exhaust gases flow out from the combustion chamber 3. The residual exhaust gases are flushed by the combustion air flowing in from the transfer channels 11 and 13 out of the combustion chamber 3. Thereafter, the air/fuel mixture for the next combustion cycle passes from the crankcase 4 into the combustion chamber 3.

In FIG. 2, the transfer channels 11 and 13 are shown open toward the cylinder outer side. In this way, the cylinder 2 can be made in a simple manner in a pressure die cast process. The transfer channels 11 and 13 are closed by separately manufactured covers not shown in FIG. 2.

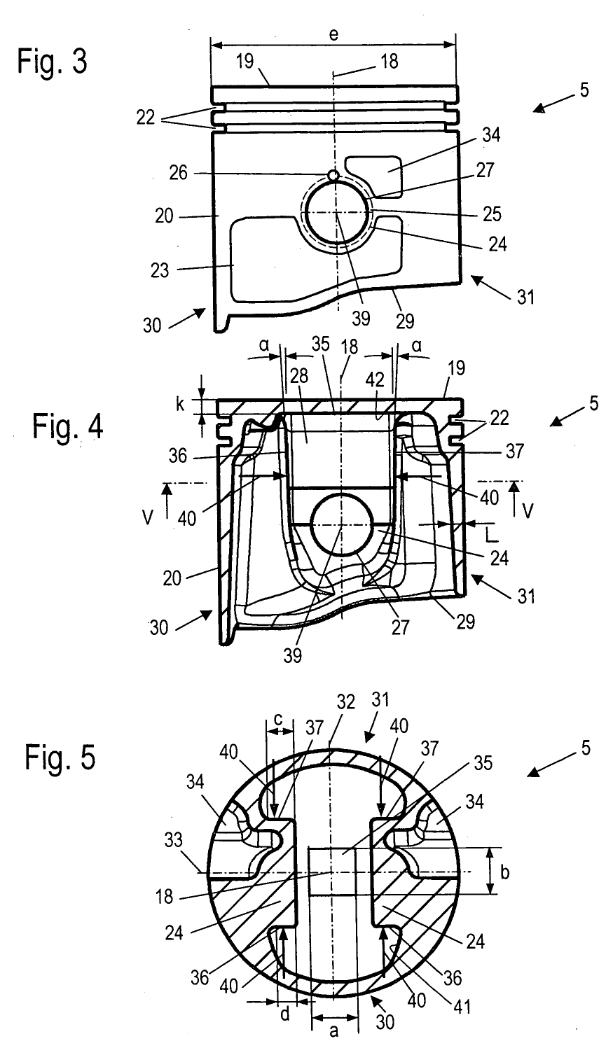

The piston 5 is shown in a side elevation view in FIG. 3. The longitudinal center axis 18 of the piston 5 is coincident with the cylinder longitudinal axis 17 in the arrangement of the piston 5 in the cylinder 2 of the two-stroke engine 1. The piston 5 shown in FIG. 3 has a piston base 19 which runs planar and perpendicularly to the longitudinal center axis 18 of the piston 5. The piston base 19 delimits the combustion chamber 3 of the two-stroke engine. The piston 5 is guided in the cylinder 2 at the piston skirt 20. The piston skirt 20 has two peripherally-extending slots 22 next to the piston base 19 for accommodating the piston rings 21 shown in FIG. 1.

The piston pocket 23 is next to a bore 27 for the piston pin 38 and is arranged on the side of the bore 27 facing away from the piston base 19. The bore 27 is arranged in the piston pin boss 24. The longitudinal axis 39 of the bore 27 runs perpendicularly to the longitudinal center axis 18 and perpendicularly to the center plane 32 of the piston 5 shown in FIG. 2. At the bore 27, the piston 5 has an annular slot 25 for accommodating a holding ring for the piston pin 38. The annular slot 25 is shown by a broken line in FIG. 3. A transverse bore 26 is arranged at the annular slot 25 and is disposed in the region of the periphery of the bore 27 and parallel to the bore 27.

Next to the bore 27, the piston 5 has a cutout 34 in the piston skirt 20 which functions to reduce weight. The cutout 34 is disposed in the region of the side 31 of the piston 5 facing toward the discharge. The piston 5 is extended toward the crankcase 4 on the opposite-lying side 30 facing toward the intake 9 of the two-stroke engine 1. The edge 29 of the piston 5 at the crankcase end does not run evenly because the edge 29 controls the intake 9 on the side 30 of the piston 5 facing toward the intake. In the region of the air inlet 16, the piston pocket 23 must be so configured that the total cross section of the air inlet 16 opens into the piston pocket 23. At the same time, the edge 29 must be arranged so deep that, at top dead center of the piston 5, no air can flow from the air inlet 16 directly into the crankcase 4. At the side 31 of the piston 5 facing toward the discharge, the edge 29 only ensures that the discharge 10 is not connected to the crankcase 4 at top dead center of the piston 5 so that here a shorter height of the piston 5 is necessary. Because of the uneven configuration of the edge 29, a clamping of the piston 5 on the edge 29 is not easily possible for machining the piston 5.

As shown in the section views of FIGS. 4 and 5, clamping surfaces 36 and 37 are provided on both piston pin bosses 24 for clamping the piston 5. The piston pin bosses 24 each have a strut 28 which extends from the bore 27 to the piston base 19. The piston 5 can be clamped in the direction of arrows 40 on the clamping surfaces 36 and 37. Both piston pin bosses 24 have a clamping surface 36 on the side thereof facing toward the side 30 of the piston and a clamping surface 37 on the opposite-lying side facing toward the side 31 of the piston 5. The clamping surfaces 36 and 37 run parallel to the longitudinal axis 39 of the bore 27 in the piston pin boss 24. With respect to a transverse plane 33, the clamping surfaces 36 and 37 are inclined at an angle α which can be from 1° to 5°. In this way, the mutually opposite-lying clamping surfaces have a greater distance from each other in the region of the piston base 19 than at the elevation of the longitudinal axis 39 of the bore 27 in the piston pin bosses 24. The transverse plane 33 extends perpendicularly to the center axis 32 and contains the longitudinal center axis 18 of the piston and the longitudinal axis 39 of the bore 27 for the piston pin 38. Perpendicular to the transverse plane, the clamping surfaces 36 and 37 are at the same distance to the transverse plane 33 at each elevation of the piston 5. The clamping surfaces (36, 37) are symmetrically arranged to the transverse plane 33 aside from their different widths (c, d) as shown in FIG. 5.

At the elevation of the longitudinal axis 39 of the bore 27, the piston skirt 20 has a wall thickness L which is 1% to 3% (especially approximately 2.5%) of the piston diameter (e) shown in FIG. 3. The piston base 19 has a thickness (k) which is 2.5% to 7% (especially approximately 5%) of the diameter (e) of the piston 5. A stop surface 35 is formed on the inner side 42 of the piston base 19 and this stop surface runs evenly and perpendicularly to the longitudinal center axis 18 of the piston 5.

In FIG. 5, the stop surface 35 is shown in plan view. In the embodiment, the stop surface 35 is rectangular and can be especially configured to be quadratic. The stop surface 35 can, however, also have another form. In the direction of the transverse plane 33, that is, parallel to the transverse plane 33 and perpendicular to the center plane 32, the stop surface 35 has a width (a) which is 10% to 25% of the diameter (e) of the piston 5. The length (b) of the stop surface 35, which is measured for this purpose in the direction of the center plane 32, amounts likewise to approximately 10% to 25% of the diameter (e) of the piston 5. The stop surface 35 is arranged centrally on the piston base 19 in the region of the longitudinal center axis 19.

Referring to FIG. 5, the two clamping surfaces 37, which are on the side of the piston pin boss 24 facing toward the side 31 of the piston 5, have a width (c) which is measured parallel to the transverse plane 33 and perpendicularly to the center plane 32 and this width (c) is advantageously approximately 5% to 12% of the diameter (e) of the piston 5. The clamping surfaces 36, which are arranged on the opposite-lying side of the transverse plane 33, have a width (d), which is measured in the same direction, and which width (d) is 3% to 10% of the diameter (e) of the piston 5. The width (d) of the clamping surfaces 36 is less than the width (c) of the clamping surfaces 37. The clamping surfaces 36 are narrower than the clamping surfaces 37 so that a nonsymmetry of the clamping surfaces (36, 37) to the transverse plane 33 results. The piston pockets 23 are arranged in the region of the clamping surfaces 36 so that the clamping surfaces 36 cannot be configured to be wider. The nonsymmetrical configuration of the piston 5 permits the alignment of a clamping tool at the differently wide clamping surfaces (36, 37) so that, thereby, a position-correct clamping can be ensured. The inner wall 41 of the piston 5 does not run symmetrically to the transverse plane 33 in the region of the piston pockets 23.

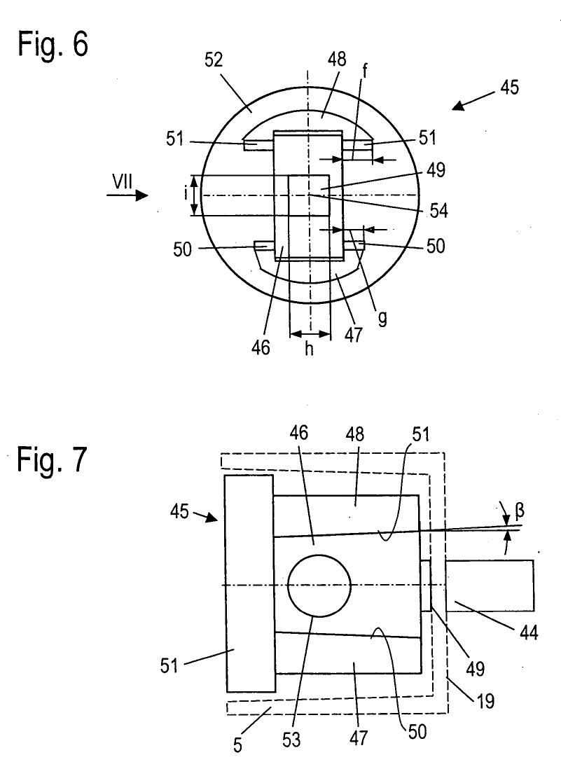

FIGS. 6 and 7 show a clamping tool 45 for clamping the piston 5. The clamping tool 45 has a first jaw 47 which clamps the piston at the side 30 facing toward the intake and a second jaw 48 which clamps the piston 5 at the opposite-lying side 31 facing toward the discharge. The two jaws 47 and 48 are moveably journalled on a base 52. A guide 46 extends between the two jaws 47 and 48 and a stop 49 is arranged on the guide 46. The stop 49 is configured slightly smaller than the stop surface 35 of the piston 5. As also shown in FIG. 7, the mutually opposite-lying grip surfaces 50 and 51 of the jaws 47 and 48 extend inclined by an angle β relative to the longitudinal axis 54 of the clamping tool 45. The angle β corresponds to the inclination angle α of the clamping surfaces 36 and 37 of the piston 5. The stop 49 runs perpendicularly to the longitudinal axis 54 and is configured to be planar. As shown in FIG. 7, the guide 46 has a bore 53 which is arranged in the region of the bore 27 in the piston pin boss 24 when the piston is clamped. The bore 53 permits a drilling of the bore 27 through both piston pin bosses 24 when the piston 5 is clamped.

As shown in FIG. 6, the stop surface 49 has a width (h) and a length (i). The width (h) is somewhat less than the width (a) of the stop surface 35 of the piston 5 and the length (i) is somewhat less than the length (b) of the stop surface 35. The width (f) of the grip surface 51 is slightly less than the width (c) of the clamping surface 37 and the width (g) of the grip surface 50 is somewhat less than the width (d) of the clamping surface 36. In this way, it is ensured that the grip surfaces 50 and 51 lie planar against the clamping surfaces 36 and 37. At the same time, the largest possible stop surface is ensured so that the clamping forces can be well introduced into the piston pin bosses 24.

For making the piston 5, the piston 5 is first made in a pressure die cast process. Here, the stop surface 35 and the clamping surfaces 36 and 37 are produced with a sufficiently high accuracy. For the machining operation, the piston 5 is clamped on the clamping tool 45. For this purpose, the clamping tool 45 is configured as a gripper and is moved into the piston 5. Only a position-correct introduction into the piston 5 is possible because of the nonsymmetrical configuration of the piston 5 and the clamping tool 45. The second jaw 48 of the clamping tool 45 is too wide in order to be introduced into the piston 5 in the region of the clamping surfaces 36. The clamping tool 45 moves into the piston 5 in the direction of the longitudinal axis 54 of the tool until the stop 49 lies against the stop surface 35. The clamping tool 45 presses the piston base 19 of the piston 5 shown in phantom outline in FIG. 7 against a counter holder 44 to ensure that the stop 49 lies firmly against the stop surface 35. Thereafter, the jaws 47 and 48 move together and clamp the piston 5 at the clamping surfaces 36 and 37.

The jaws 47 and 48 first clamp the piston 5 with reduced clamping force and the bore 27 is drilled into the piston pin bosses 24 while the counter holder 44 still lies against the piston base 19. Thereafter, the clamping force is increased so that the piston 5 is held tightly against the clamping tool 45 and the counter holder 44 is removed. In that the clamping tool 45 only grips at the piston pin bosses 24, there results only minimal deformation at the piston skirt 20. Thereafter, the piston 5 is machined at the piston skirt 20 and the piston base 19 until the desired roughness of the surfaces is achieved. In the same clamping state, at least one slot for a piston ring is cut in. It can also be advantageous to make the slot 22 for the piston ring 21 in advance of machining the piston skirt 20. An annular slot 25 is cut into the piston pin boss 24 and the bore 26 is drilled. This machining too can take place at reduced clamping force on the piston pin bosses 24. No high accuracy in the radial direction toward the longitudinal axis 39 of the piston pin 38 is needed for the annular slot 25. For this reason, the annular slot 25 can, however, also be introduced at increased clamping forces on the clamping tool 45. A bore 26 is drilled for the bosses on the holding ring at the annular slot 25. In this way, all machining operations of the piston 5 can take place in one clamping state.

The piston 5 can be made with high accuracy so that reduced wall thicknesses at the piston skirt 20 and at the piston base 19 can be realized. Because of the nonsymmetry of the piston 5 to the center axis 32, the clamping tool 45 and the piston 5 can be aligned to each other in advance of clamping the piston 5 so that a position-correct clamping of the piston 5 is ensured.

It is understood that the foregoing description is that of the preferred embodiments of the invention and that various changes and modifications may be made thereto without departing from the spirit and scope of the invention as defined in the appended claims.

What is claimed is:

1. A piston for a two-stroke engine, the piston comprising:
a piston body having a base;
two piston pin bosses formed on said body;
said piston pin bosses having respective bores formed therein for accommodating a piston pin; and,
said piston pin bosses each having opposite-lying planar first and second clamping surfaces formed thereon.

2. The piston of claim 1, wherein said piston body defines a piston longitudinal center axis and said bores define a bore longitudinal axis; said piston longitudinal center axis and said bore longitudinal axis conjointly define a transverse plane; and, said clamping surfaces extend parallel to said bore longitudinal axis and inclined with respect to said transverse plane at an angle (α) of inclination in the range of 1° to 5°.

3. The piston of claim 2, wherein said clamping surfaces all lie at the same distance from said transverse plane.

4. The piston of claim 2, said first clamping surfaces of said piston pin bosses, respectively, lying on one side of said transverse plane and said second clamping surfaces of said piston pin bosses, respectively, lying on the other side of said transverse plane.

5. The piston of claim 2, wherein said piston body defines a center plane containing said piston longitudinal center axis; said center plane extends perpendicularly to said bore longitudinal axis; said piston body has a skirt and at least one piston pocket open to said skirt; said piston body further has an inner wall; and, said inner wall and said piston pocket are configured to be nonsymmetrical to said center plane.

6. The piston of claim 5, said piston base having an inner side and a stop surface formed on said inner side; and, said stop surface being configured to have a planar configuration and being perpendicular to said piston longitudinal center axis.

7. The piston of claim 6, wherein said piston has a diameter (e); said stop surface has a width (a) of 10% to 25% of said diameter (e) and a length (b) of 10% to 20% of said diameter (e).

8. The piston of claim 7, wherein said base of said piston has a thickness (k) of 2.5% to 7% of said diameter (e) of said piston and said skirt has a wall thickness (L) at the elevation of said bore longitudinal axis of 1% to 3% of said diameter (e) of said piston.

9. The piston of claim 8, wherein said thickness (k) is 5% of said diameter (e) of said piston and said thickness (L) of said skirt at said elevation of said bore longitudinal axis is 2.5% of said diameter (e) of said piston.

10. A method for making a piston including: a piston body having a base defining an inner side; a piston pin boss formed on said body; said piston body further having a skirt; said piston pin boss having at least two opposite-lying planar first and second clamping surfaces formed thereon; and, said piston having a planar stop surface disposed on said inner side of said base; and, the method comprising the steps of:
providing a clamping device for clamping and holding said piston and said clamping device having a stop formed thereon;
moving said clamping device into said piston until said stop comes into contact with said planar stop surface of said piston so as to cause said base of said piston to be pressed against a counter holder;
grasping and clamping said piston at said clamping surfaces with said clamping device;
removing said counter holder after said piston is grasped and clamped with said clamping device at said clamping surfaces; and,
machining said base and said skirt of said piston while said piston is clamped.

11. The method of claim 10, comprising the further step of, after said piston has been clamped, drilling a bore in said piston pin boss with the clamping force at said clamping surfaces being reduced and with said counter holder being at said base of said piston.

12. The method of claim 11, wherein said piston pin boss has a bore formed therein; and wherein said method comprises the further steps of:
in the clamped state, cutting an annular slot into said piston pin boss at said bore; and,
drilling a bore into said piston pin boss at said annular slot.

13. The method of claim 10, comprising the further step of, in the clamped state, cutting at least one slot into said piston body for accommodating a piston ring.

14. The method of claim 12, wherein said piston body defines a longitudinal center axis and said bore defines a bore longitudinal axis and said piston body further defines a center plane containing said piston longitudinal center axis and said bore longitudinal axis; the method comprising the further steps of:
forming said first and second clamping surfaces unsymmetrically with respect to said center plane; and,
before grasping and clamping said piston, aligning said clamping device to the nonsymmetry of said clamping surfaces.

15. The method of claim 10, the method comprising the step of producing said piston body in a pressure die-casting process with said clamping surfaces and said stop surface in advance of machining said piston body.
